(19) United States
(12) Patent Application Publication
(10) Pub. No.: US 2008/0148973 A1
(43) Pub. Date: Jun. 26, 2008

(54) Device for controlling a rotary press for printing a web of material and rotary press

(75) Inventor: Henri Pollet, Vieux-Moulin (FR)

Correspondence Address: Davidson, Davidson & Kappel, LLC, 485 7th Avenue, 14th Floor, New York, NY, 10018, US

(73) Assignee: GOSS INTERNATIONAL MONTATAIRE SA, Montataire (FR)

(21) Appl. No.: 12/004,211

(22) Filed: Dec. 20, 2007

(30) Foreign Application Priority Data
Dec. 21, 2006 (FR) 06 11219

(51) Int. Cl. B41F 13/56

(52) U.S. Cl. 101/226

(57) ABSTRACT

A control device is provided including a control desk including an analysis table which is to receive at least one printed sample to be checked.

According to one embodiment of the invention, the device includes a detecting device suitable for providing a measurement of the position of a marker printed on the sample relative to a reference element of the sample placed on the analysis table.

Application to the adjustment of the lateral register of printing cylinders, the circumferential register of printing cylinders, and/or the cutting register of a unit for the transverse cutting of the web is provided.

This claims the benefit of French Patent Application No. 06 11219, filed on Dec. 21, 2006 and hereby incorporated by reference herein.

### TECHNICAL FIELD OF THE INVENTION

The present invention relates to a device for controlling a rotary press for printing a web of material, of the type comprising a control desk comprising an analysis table which is to receive at least one printed sample to be checked.

### BACKGROUND TO THE INVENTION

A rotary press generally comprises, among other things, a plurality of printing units for printing a continuous web of material moving through the printing units, and one or more cutting unit(s), located downstream of the printing units, for cutting the web into sheets.

The rotary press has to be adjusted, in particular in order to ensure that the images printed on the web by the various printing units are correctly superimposed on each other and that the web is cut along appropriate lines between the images.

To that end, the rotary press comprises actuators for adjusting the position of printing cylinders of the printing units in such a manner as to adjust the relative position of the various images printed by the various printing cylinders, and for adjusting the position of cylinders for the transverse cutting of the web, in such a manner as to adjust the position of the cutting lines.

Nevertheless, rotary presses are very complex and very expensive machines which are complicated to adjust.

### SUMMARY OF THE INVENTION

An object of the invention is to provide a device for controlling a rotary press which enables the press to be adjusted and which is simple to bring into operation, inexpensive and simple to use.

To that end, the invention provides a control device wherein it comprises a detecting device suitable for providing a measurement of the position of a marker printed on the sample relative to a reference element of the sample placed on the analysis table.

According to other embodiments, the control device may include one or more of the following features, taken in isolation or in accordance with any technically possible combination:

the control device may be suitable for measuring the distance between a marker printed on the sample and an edge of the sample forming the reference element of the sample;

the edge of the sample may be an edge of the sample resulting from the transverse cutting of the web in the rotary press, the detecting device enabling the cutting register of the rotary press to be adjusted;

the detecting device may be suitable for detecting the position on the printed sample of a marker printed on the sample by a first printing cylinder relative to another reference marker printed on the sample by another printing cylinder;

the control device may include at least one ruler for positioning a reference edge of the printed sample on the analysis table;

the control device may include at least one system for controlling the rotary press, which system is connected to the detecting device, the control system being suitable for receiving the measurement(s) taken by the detecting device, and for controlling actuators of a rotary press in order to modify at least the lateral register of the printing cylinders, the circumferential register of the printing cylinders, and/or the cutting register of a unit for cutting the web.

The invention also provides a rotary press for the recto or recto-verso printing of a web of material, comprising units for printing a web of material, and at least one unit for the transverse cutting of the web of material, comprising a control device such as defined above.

### BRIEF DESCRIPTION OF THE DRAWINGS

The invention and its advantages will be better understood on reading the following description which is given purely by way of example and with reference to the appended drawings, in which:

FIG. 1 is a general diagrammatic view of a rotary press having a control device according to the invention;

FIG. 2 is a partial perspective diagrammatic view of a printing unit of the rotary press of FIG. 1;

FIG. 3 is a perspective diagrammatic view of a control desk of the control device of FIG. 1;

FIG. 4 is a partial top view of the desk of FIG. 3; and

FIGS. 5 and 6 are enlarged views of the zone V of FIG. 4 illustrating various configurations.

### DESCRIPTION OF PREFERRED EMBODIMENTS

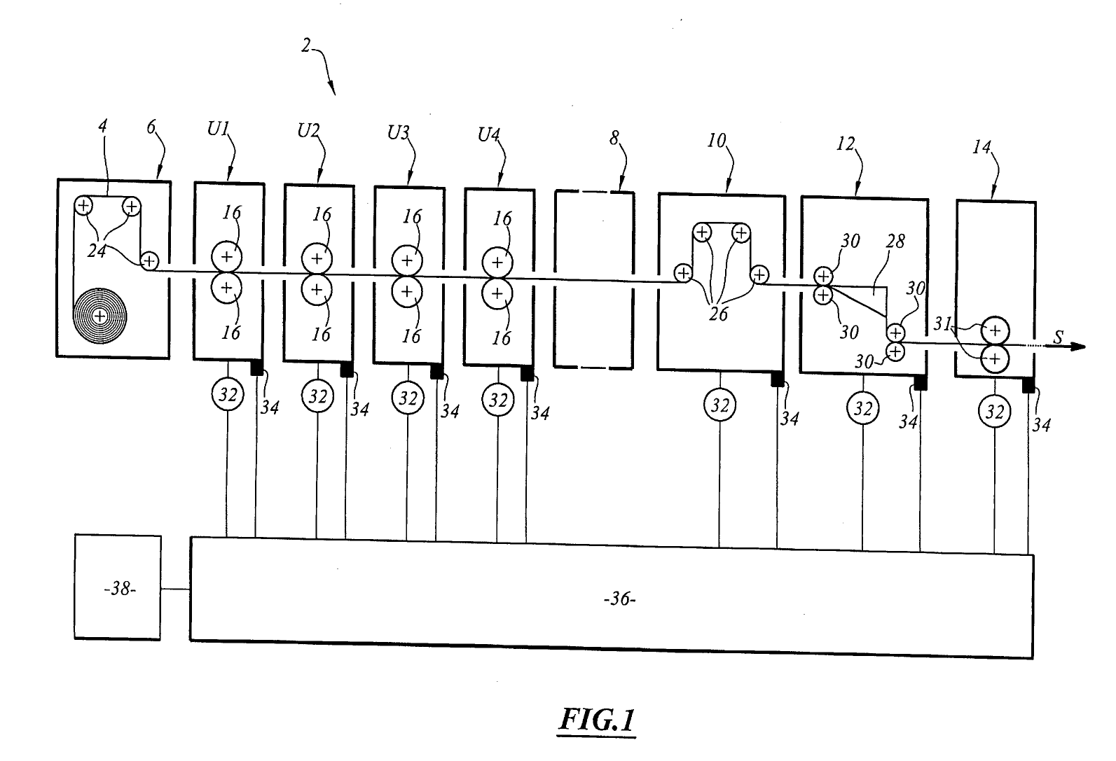

FIG. 1 illustrates a rotary press 2 which is to print a web 4, for example, a web of paper.

During printing operations, the web 4 moves through the press 2, under tension and at high speed, following a path of movement, from left to right in FIG. 1, as illustrated by the arrow S.

In the following description, the terms “longitudinal”, “transverse”, “lateral”, “upstream” and “downstream” are to be understood in relation to the web 4 and to the direction of movement of the web 4 in the press 2.

The press 2 comprises a plurality of operational units, including in succession from upstream to downstream, a unit 6 for unwinding the web 4 from a roll, units U1, U2, U3, U4 for printing the web 4, a unit 8 for drying the web 4 after printing, a unit 10 for cooling the web 4 after drying, a unit 12 for the longitudinal folding of the web 4, and a unit 14 for the transverse cutting of the web 4.

The cutting unit 14 can simultaneously cut and fold transversely the web 4.

In the example illustrated, the printing units U1, U2, U3, U4 are twin units for the recto-verso printing of the web 4.

Each printing unit U1, U2, U3, U4 comprises two printing cylinders 16 located one on each side of the web 4 and mounted in such a manner as to grip the web between them. The cylinders 16 are supplied with ink in a conventional manner in order to print the desired images on the two faces of the web 4.

The cylinders 16 of a unit U1, U2, U3, U4 print the web 4 and also contribute to the feeding of the web 4.

The drying unit 8 comprises means for heating the web 4 in order to dry the ink deposited on the web 4. The cooling unit 10 comprises cylinders 26 for diverting the web 4.

In known manner, the folding unit 12 comprises a triangle 28 for the longitudinal folding of the web 4, and two pairs of cylinders 30 for feeding the web 4, comprising a pair upstream and a pair downstream of the triangle 28. The two cylinders 30 of each pair grip the web 4 between them.

The cutting unit 14 comprises two cutting cylinders 31. For example, in a conventional manner, one of the cylinders 31 carries transverse blades on its circumference, and the other cylinder is provided with grooves for receiving the blades. The web 4 passing between the cylinders 31 is cut between the blades and the grooves along transverse lines.

The press 2 comprises devices 32 for driving the cylinders 16, 26, 30 and 31 of the units U1, U2, U3, U4, 10, 12 and 14, and detecting devices 34 suitable for emitting signals representing the angular position and/or the angular velocity of said cylinders.

The press 2 comprises a control device including a control system 36 which is connected to the devices 34 in order to receive the measurement signals emitted by those devices, and which is connected to the devices 32 in order to synchronize the rotation of the cylinders 16, 26, 30 and 31 of the units U1, U2, U3, U4, 10, 12 and 14 during printing operations.

The control device of the press 2 comprises a control station 38 enabling an operator to monitor and control the printing operations. The station 38 is connected to the control system 36.

During printing operations, the printing units U1, U2, U3, U4 print images of various colors. The printing colors are the following: black, cyan, magenta and yellow.

The images of the various printing units U1, U2, U3, U4 are superimposed on each other to form an image in color. The superimposition of the images printed by the various cylinders should be correct.

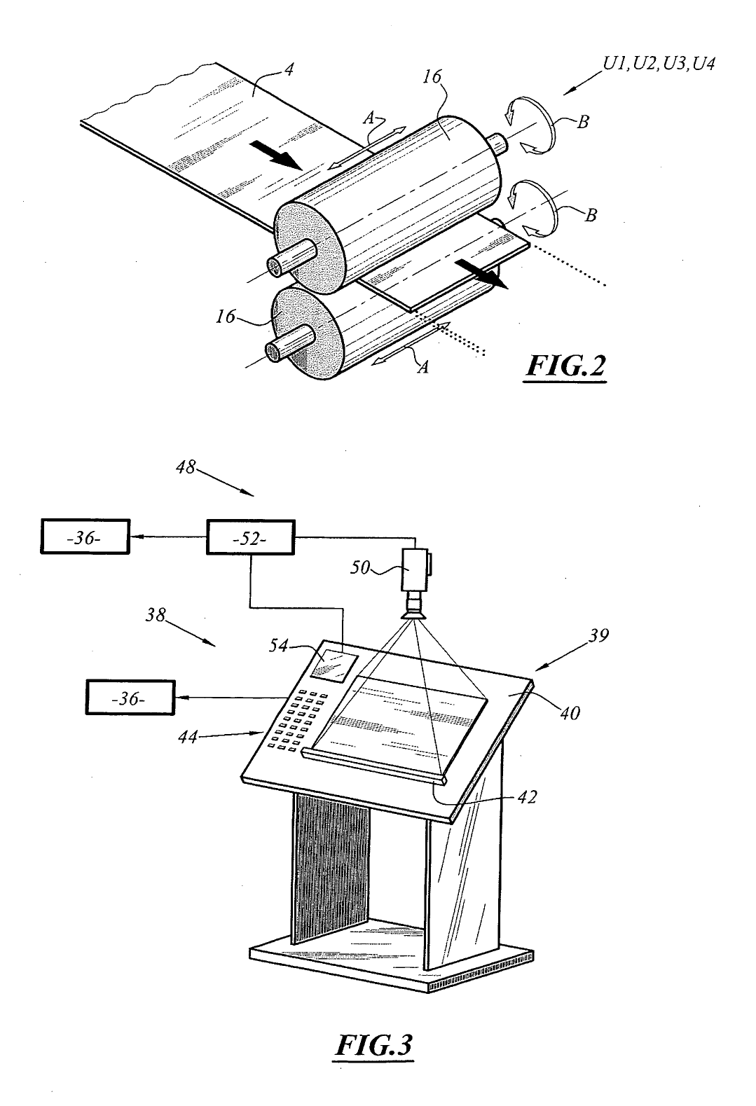

As illustrated in FIG. 2, the press 2 has actuators enabling the position of the cylinders 16 of the printing units U1, U2, U3, U4 to be adjusted.

More precisely, the press 2 comprises actuators for adjusting the position of each cylinder 16 along the cylinder's rotation shaft which extends transversely to the web 4 (arrow A). This adjustment enables the transverse position of the image printed by each cylinder 16 on the web 4 to be adjusted and is generally called “lateral register.”

The press 2 comprises actuators for adjusting the angular position of each cylinder 16 (arrow B), and in particular for adjusting the phase shift of each cylinder 16 relative to the other cylinders printing on the same face of the web 4.

Adjustment of the angular phase shift of a cylinder 16, or “circumferential register”, modifies the position of the image printed by that cylinder in accordance with the longitudinal direction of the web 4.

In the case of a press having an individual motor associated with each printing cylinder, or with each pair of printing cylinders of a recto-verso printing unit, the circumferential register of a printing cylinder is, for example, effected by operating the motor associated with the printing cylinder in order to advance or delay said cylinder relative to the other printing cylinders.

Analogously, the unit 14 comprises actuators for adjusting the angular phase shift of the cylinders 31 relative to the cylinders 16, in such a manner as to modify the adjustment of the position of the transverse cutting lines relative to the images printed on the web 4, or “cutting register”.

As illustrated in FIG. 3, the control station 38 has a desk 39 comprising an inclined analysis table 40 provided for the placement thereon of a sheet leaving the press 2, a horizontal ruler 42 located on the table 40, and a control panel 44.

The analysis table 40 enables the operator to place thereon a sheet taken as a sample as it leaves the press 2, after the cutting unit 14, in order to check visually that the web 4 has been printed correctly and, if necessary, to provide information for adjusting the various units of the press 2, which will be taken into account by the control system 36 in order to control the actuators of the press 2, or, where appropriate, will be transmitted by the control system 36 to other operators stationed in the vicinity of the various units, each operator being able to monitor and control the adjustment of one or more units.

In accordance with the invention, the desk 38 also comprises a detecting device 48 enabling the operator to be assisted in providing adjustment information.

The device 48 comprises a photographing apparatus 50, for example a camera, arranged in such a manner as to capture an image of a sheet placed on the table 40 and resting by one edge on the ruler 42.

The device 48 also comprises an image-processing unit 52 suitable for determining specific measurements on the basis of an image captured by the apparatus 50.

The device 48 optionally also comprises a unit 54 for displaying the measurements.

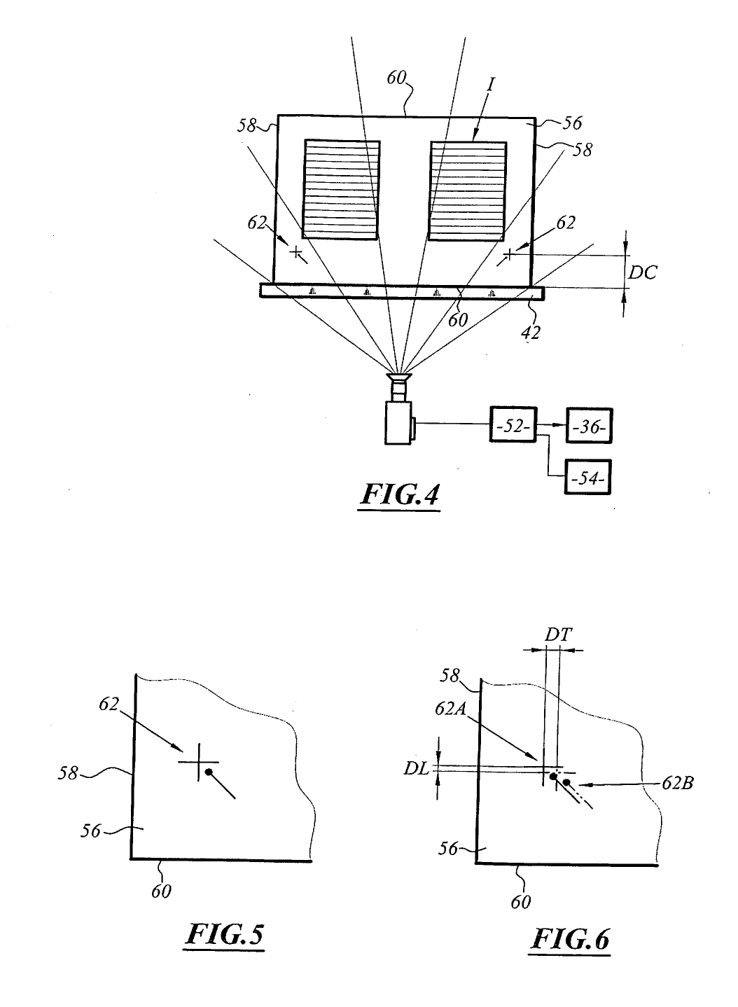

As shown in FIG. 4, a sheet 56 taken as a sample as it leaves the press 2 of FIG. 2 has two edges 58 corresponding to the longitudinal edges of the web 4, and two edges 60 cut in the cutting unit 14.

The operator positions the sheet 56 in such a manner that it rests by a lower edge 60 on the ruler 42, which acts as a position reference for said lower edge 60.

The sheet 56 has markers 62 printed by the printing units U1, U2, U3, U4 in the two corners of the sheet 56 that are adjacent to the lower edge 60, at the same time as an image I.

The unit 52 is suitable for determining from an image taken by the apparatus 50 the distance DC between each marker 62 and the lower edge 60.

That distance represents the angular phase shift between the cylinders 16, which print the markers 62, and the cylinders 31, which cut the web 4. The measurement of the distance DC enables the cutting register of the press 2 to be adjusted.

The device 48 displays the measurement on the unit 54. The operator present at the station 48 can validate the measurement, which is then transmitted to the control system 36 with a view to automatic adjustment or with a view to transmission to operators stationed at the various units of the press 2.

The markers printed by the various printing cylinders are, for example, identical in form. In that case, as shown in FIG. 5, when the cylinders 16 are correctly adjusted relative to each other, the markers are substantially perfectly superimposed, so that a single marker 62 is visible.

As shown in FIG. 6, if a marker 62A is offset relative to a marker 62B, the unit 52 is capable of determining the distance DL between the markers 62A, 62B in the longitudinal direction of the web, and the distance DT between the markers 62A, 62B in the transverse direction of the web.

The unit 52 advantageously uses the fact that the markers printed by the various cylinders have different colors to differentiate between them, and to associate each marker with a printing cylinder.

In a variant, the markers printed by the various printing cylinders are offset when the printing registers are correctly adjusted, and the unit 52 is capable of differentiating between each marker and of detecting a difference in the relative position of the markers with respect to a relative position of the reference markers.

Optionally or alternatively, the markers may be in different forms in order to distinguish them.

Optionally or alternatively, the device 48 measures the distance of a marker 62 relative to an edge 58 of the sheet 56 parallel to a longitudinal edge of the web 4 or constituting a longitudinal edge of the web 4, in order to adjust the lateral register of each of the printing cylinders, or of a printing cylinder acting as a reference for the other printing cylinders, for example, the cylinder printing in black. Thus, the lateral register of the cylinders is adjusted by reference to the web, and not purely in a relative manner between the printing cylinders.

The device 48 displays the measurement on the unit 54. The operator present at the station 48 can validate the measurement, which is transmitted to the control system 36 with a view to automatic adjustment, or with a view to transmission to operators stationed at the various units of the press 2.

Advantageously, the lateral register and the circumferential register of the printing cylinders may be adjusted relative to the position of a reference cylinder, for example, the cylinder printing in black.

The device 48 enables the measurements of the position of the markers 62 to be effected automatically. Thus, the measurements may be effected more rapidly, more reliably and more accurately than if they were effected manually by an operator by means of a measuring instrument, such as a ruler.

The device 48 may be easy to use because the operator simply has to position the sheet 56 correctly, and, from that moment, the device 48 is capable of effecting measurements. The measurements are effected in the context of normal print-checking operations carried out by the operator.

The lateral register, the circumferential register and the cutting register are modified in accordance with the measurements carried out by the device 48, either automatically by the system 56, or semi-automatically, after validation by the operator of station 48, and/or transmission to operators stationed at the units of the press, and, where appropriate, validation by those operators. The semi-automatic adjustment of the registers thus enables the operator(s) to carry out a check.

The device 48 may be simple and inexpensive. In particular, the device can be readily fitted on a pre-existing press without any major modification to the press 2, since it is necessary only to add the device 48 to a control station which, moreover, already exists on the majority of rotary presses.

The device 48 may be simpler to put to use than completely automated adjusting means which have measurement means located along the path of the web in the press.

The device 48 can be used for adjustments to the lateral register, the circumferential register and the cutting register, or for one or two of those registers only.

What is claimed is:

1-7. (canceled)

8. A device for controlling a rotary press for printing a web of material, comprising a control desk comprising:
an analysis table for receiving at least one printed sample to be checked; and
a detector for providing a measurement of the position of a marker printed on the sample relative to a reference element of the sample placed on the analysis table.

9. The device as recited in claim 8 wherein the detector is suitable for measuring the distance between a marker printed on the sample and an edge of the sample forming the reference element of the sample.

10. The device as recited in claim 9 wherein the edge of the sample is an edge of the sample resulting from the transverse cutting of the web in the rotary press, the detector enabling the cutting register of the rotary press to be adjusted.

11. The device as recited in claim 8 wherein the detector is suitable for detecting the position on the printed sample of a marker printed on the sample by a first printing cylinder relative to another reference marker printed on the sample by another printing cylinder.

12. The device as recited in claim 8 further comprising at least one ruler for positioning a reference edge of the printed sample on the analysis table.

13. The device as recited in claim 8 further comprising at least one controller for controlling the rotary press, the controller being connected to the detector, the controller being suitable for receiving the measurement taken by the detector, and for controlling actuators of a rotary press in order to modify at least one of a lateral register of the printing cylinders, a circumferential register of the printing cylinders, and a cutting register of a unit for cutting the web.

14. A rotary press for the recto or recto-verso printing of a web of material, comprising:
print units for printing a web of material;
at least one cutter for the transverse cutting of the web of material; and
the control device as recited in claim 8.

15. A method for controlling a rotary press comprising:
printing a web of material with a marker;
cutting the web of material into printed products;
placing a printed product with the marker on an analysis table;
detecting the marker with a detector; and
automatically altering the printing as a function of an output of the detector.
